(19) United States
(12) Patent Application Publication
(10) Pub. No.: US 2003/0154961 A1
(43) Pub. Date: Aug. 21, 2003

(54) Fastening device

(76) Inventor: Uwe Liskow, Asperg (DE)

Correspondence Address: KENYON & KENYON, ONE BROADWAY, NEW YORK, NY, 10004, US

(21) Appl. No.: 10/275,053

(22) PCT Filed: Feb. 27, 2002
(86) PCT No.: PCT/DE02/00696

(30) Foreign Application Priority Data
Feb. 28, 2001 (DE) 101 09 408.6

(51) Int. Cl. F02M 61/14

(52) U.S. Cl. 123/470

(57) ABSTRACT

A mounting device for securing a fuel injector (1) in a cylinder head (2) of an internal combustion engine has at least one hold-down device (11) which is mounted on a front face (12) of the cylinder head (2) and secures fuel injector (1) in a receiving bore (9) of the cylinder head (2). The at least one hold-down device (11) is supported by a shoulder (7) which is formed at the downstream end (6) of the fuel injector (1) and surrounds the fuel injector (1) at least partially.

### BACKGROUND INFORMATION

The present invention is directed to a mounting device for securing a fuel injector according to the definition of the species in the main claim.

A mounting device for mounting a fuel injector on an intake manifold, which axially attaches the fuel injector to the fuel distribution line or to a plug nipple by using a mounting element which is designed as a U-shaped clamp having two legs which are elastic in the radial direction, is known from German Patent 29 26 490 C2. In the assembled state, the clamp reaches through corresponding recesses of the plug nipple and is snappable into a recess in a connection fitting of the fuel injector, the recess being designed as a ring groove. The axial clearance between the recesses and the clamp as well as between the ring groove and the clamp should be kept small, in order to achieve accurate fixation of the fuel injector without stressing the gasket.

The stressing effect of the different mounting parts on the fuel injector is a particular disadvantage of the mounting device known from German Patent 29 26 490 C2. The power flow generated in the fuel injector results in deformations and thus to changes in the lift of the valve needle including jamming, as well as in a compression and bending strain of the housing parts, which are generally thin-walled and welded together at several points. In addition, any fixation measure, e.g., the use of a bearing collar, results in an enlargement of the radial dimension of the fuel injector and thus in an increase in required space for mounting.

### ADVANTAGES OF THE PRESENT INVENTION

The mounting device for a fuel injector according to the present invention having the characterizing features of the main claim has the advantage over the related art that the fuel injector has a collar or shoulder which is mounted on a spray-discharge-side end at which an elastic hold-down device engages, which completely or partially surrounds the end of the fuel injector, whereby the fuel injector is held down in the cylinder head. Thus, axial or bending forces act only on the valve housing at the downstream end.

Due to the measures recited in the subclaims, advantageous refinements of and improvements on the mounting device indicated in the main claim are possible.

It is a particular advantage that the hold-down devices are easily manufacturable by stamping them out of sheet metal and that they are suitable for individual fuel injectors, as well as for in-line arrangements of fuel injectors.

Advantageously, the hold-down devices are fixed in a simple manner to the front face of the cylinder head by using screws or clamping claws.

It is a further advantage that the hold-down device is designed as a hold-down pot, which adds greater stability to the fuel injector in the receiving bore of the cylinder head.

It is also of advantage here that the slots and elastic clips formed at the end of the hold-down pot allow a quick and simple assembly and disassembly of the fuel injector.

Due to shoulders in the hold-down pot, the mounting device is installable in almost any receiving bore of a cylinder head, and may thus be used as an adapter when the bore cross-section is excessively large.

### DRAWING

Exemplary embodiments of the present invention are illustrated in the drawing in simplified form and are explained in greater detail in the following description.

FIG. 1 shows a schematic view of a first exemplary embodiment of a mounting device for a fuel injector designed according to the present invention,

FIGS. 2A-B each show a schematic top view of the mounting device designed according to the present invention,

FIG. 3 shows a schematic top view of a second exemplary embodiment of a mounting device according to the present invention,

FIG. 4 shows a schematic sectional view of the mounting device illustrated in FIG. 3, and

FIG. 5 shows a schematic view of the mounting process of a fuel injector using the mounting device illustrated in FIG. 3 and FIG. 4.

### DESCRIPTION OF THE EXEMPLARY EMBODIMENTS

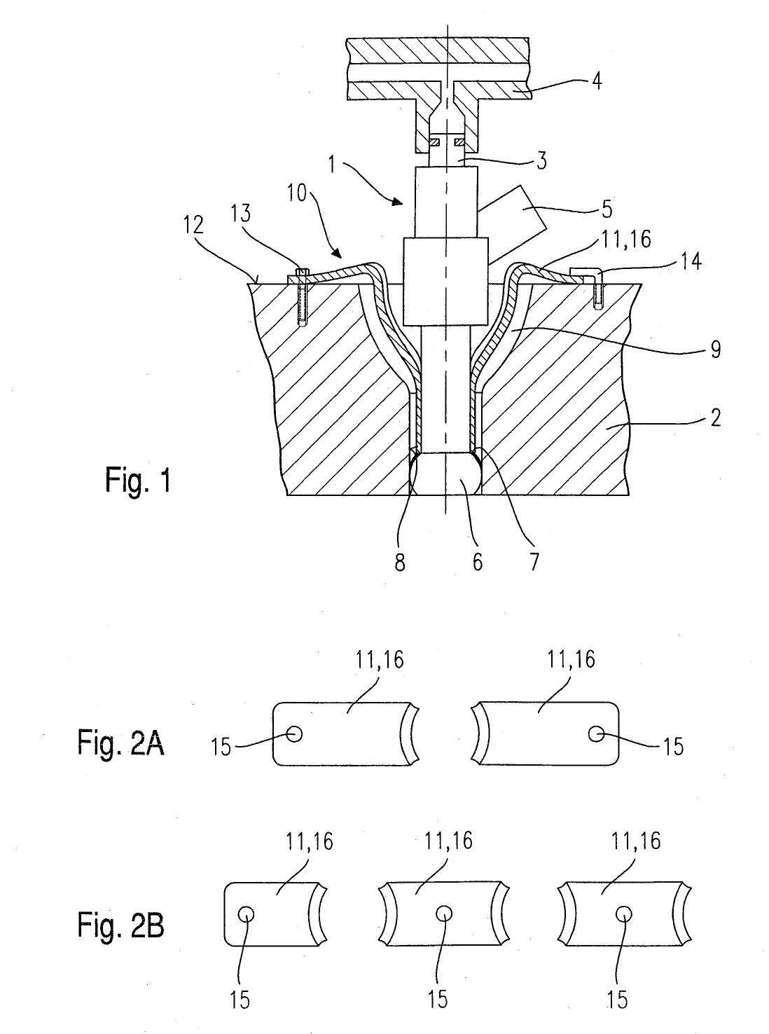

FIG. 1 shows a highly schematic partial section through a first exemplary embodiment of a mounting device for a fuel injector designed according to the present invention.

A fuel injector 1 is designed here in the form of a direct injecting fuel injector 1 which is installed in a cylinder head 2 for direct injection of fuel into the combustion chamber of, in particular, a mixture-compressing, spark-ignited internal combustion engine (not shown). At an inflow-side end 3, fuel injector 1 has a connection to a fuel supply line 4. Fuel injector 1 has a terminal 5 for the electrical contact for the actuation of the fuel injector.

A shoulder 7, which is in contact with a wall 8 of a receiving bore 9 of cylinder head 2, is formed at a downstream end 6 of fuel injector 1. Shoulder 7 may be manufactured by turning, or it may be attached by welding a spherical shape to the downstream end 6 of fuel injector 1, whereby, in addition, good guidance in receiving bore 9 is achieved.

In order to secure fuel injector 1 in receiving bore 9 of cylinder head 2, a mounting device 10 is provided according to the present invention. Mounting device 10 includes a hold-down device 11, which has a two-part design in the present first exemplary embodiment and rests on downstream end 6 of fuel injector 1. Preferably, hold-down device 11 is stamped out of sheet metal, for example. Hold-down devices 11 are supported by shoulder 7, which is formed at downstream end 6 of fuel injector 1. Hold-down devices 11 are secured with side parts 16 on front face 12 of cylinder head 2, either, as illustrated in FIG. 1 left, by a screw 13 screwed into cylinder head 2, or, as illustrated in FIG. 1 right, by a clamping claw 14 also attached to front face 12 of cylinder head 2. The clamping claw is easier to assemble, since a bore in hold-down device 11 is not needed.

The preferred shape of hold-down device 11 is selected here in such a way that a spring action is created by securing side parts 16 to front face 12 of cylinder head 2, and the spring action presses fuel injector 1 into receiving bore 9 in cylinder head 2 via shoulder 7. The axial stability of fuel injector 1 is achieved not only through the guidance of fuel supply line 4, but also by the fact that hold-down devices 11 partially surround fuel injector 1 in the area of its downstream end 6.

FIGS. 2A and 2B show a schematic top view of two variants of mounting device 10 of fuel injector 1 according to the present invention. Identical components are denoted by identical reference symbols in all figures.

Looking at mounting device 10 in the flow direction of the fuel, side parts 16 of hold-down devices 11, which protrude over front face 12 of cylinder head 2, are recognizable. In FIGS. 2A and 2B the hold-down devices are provided with bores 15 for example for mounting on cylinder head 2.

FIG. 2A shows a symmetrical pair of hold-down devices 11, used for mounting of an individual fuel injector 1, while FIG. 2B takes into account a possible arrangement of several fuel injectors 1 in a line, in which for easier mounting and for further stability each adjacent hold-down device 11 has a one-piece design.

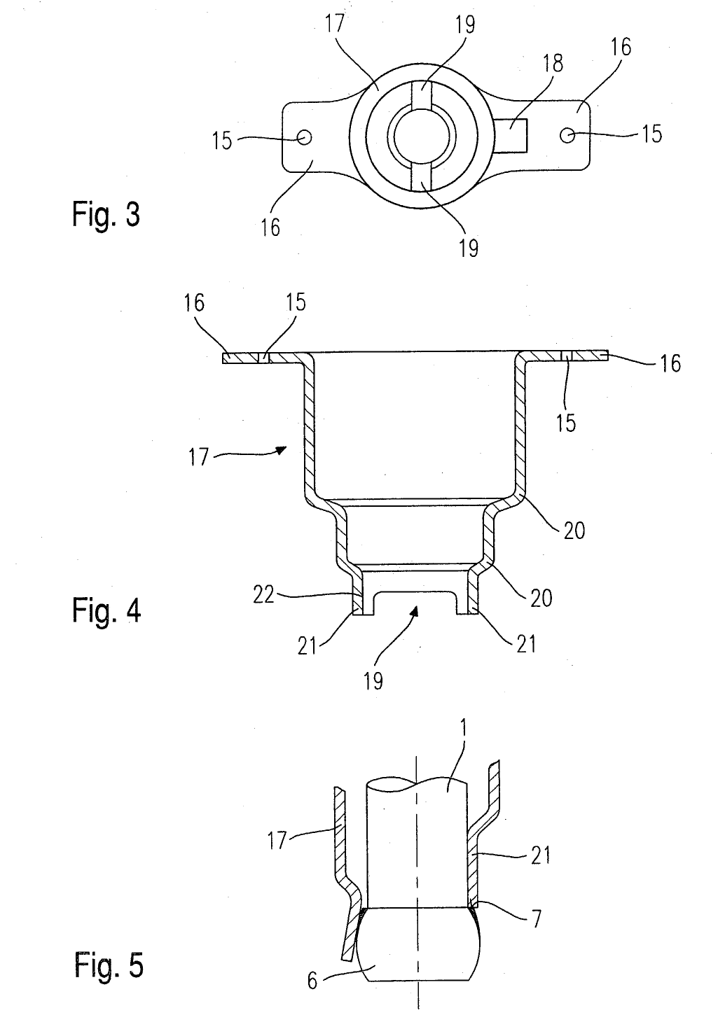

FIG. 3 shows a schematic top view of a second exemplary embodiment of a mounting device 10 for a fuel injector 1 designed according to the present invention.

In contrast to the exemplary embodiment of mounting device 10 described in FIG. 1, the second exemplary embodiment described in FIG. 3 has a one-piece, i.e., pot-shape, design. A hold-down pot 17 has in turn two side parts 16 having bores 15 for mounting hold-down pot 17 on front face 12 of cylinder head 2. A recess 18 is used as a feed-through for the electric line (not shown) for actuating fuel injector 1. Such a hold-down pot 17 may be manufactured by deep-drawing, for example.

In order to insert fuel injector 1 with shoulder 7, formed at its downstream end 6, into hold-down pot 17, at least one slot 19 is provided (there are two in the present exemplary embodiment), which are symmetrically situated at a downstream end 22 of hold-down pot 17. In order to adapt to the outer shape of fuel injector 1, i.e., receiving bore 9 of cylinder head 2, hold-down pot 17 has several shoulders 20, as is made clear in FIG. 4.

FIG. 5 shows a schematic view of the mounting process of a fuel injector 1 using mounting device 10 shown in FIGS. 3 and 4.

As mentioned above, at least one slot 19 must be provided in a pot-shaped design of mounting device 10 in order to snap end 6 of fuel injector 1, thickened by shoulder 7, into hold-down pot 17. The process used for inserting fuel injector 1 into hold-down pot 17 is illustrated in FIG. 5 in a highly schematic form.

As fuel injector 1 is inserted, clips 21 of hold-down pot 17 situated adjacent to slot 19 initially recede due to the pressure on shoulder 7 situated at downstream end 6 of fuel injector 1. This is recognizable in the left section of FIG. 5.

If fuel injector 1 is pressed further into hold-down pot 17 against the elastic force of clips 21, then the clips snap back into their original shape at the upstream side of shoulder 7, and come to rest on fuel injector 1. By briefly tightening installed fuel injector 1 it may be achieved that clips 21, supported by shoulder 7, secure fuel injector 1 after assembly of fuel injector 1 and hold-down pot 17 in receiving bore 9 of cylinder head 2. Should fuel injector 1 be disassembled, it is pulled out of holding-down pot 17, which is facilitated by a spherical shape of shoulder 7.

As in the first exemplary embodiment, holding-down pot 17 may be mounted by using screws 13, which are guided through bores 15, or by using clamping claws.

The present invention is not limited to the illustrated exemplary embodiment and is, for example, also applicable to fuel injectors 1 for injection into the combustion chamber of a self-igniting internal combustion engine.

What is claimed is:

1. A mounting device for securing a fuel injector (1) in a cylinder head (2) of an internal combustion engine, comprising at least one hold-down device (11) which is secured to one front face (12) of the cylinder head (2) and fixes in position the fuel injector (1) in a receiving bore (9) of the cylinder head (2),
wherein the at least one hold-down device (11) is supported by a shoulder (7) which is formed at a downstream end (6) of the fuel injector (1), and which surrounds the fuel injector at least partially, the hold-down device (11) being formed in such a manner that it is pre-stressed in its mounted state.

2. The mounting device as recited in claim 1,
wherein the at least one hold-down device (11) has a side part (16) which protrudes over the front face (12) of the cylinder head (2).

3. The mounting device as recited in claim 1 or 2,
wherein the side part (16) of the at least one hold-down device (11) is secured to the front face (12) of the cylinder head (2) by at least one screw (13) which reaches through at least one bore (15) in the side part (16).

4. The mounting device as recited in claim 1 or 2,
wherein the side part (16) of the at least one hold-down device (11) is secured to the front face (12) of the cylinder head (2) by at least one clamping claw (14) which presses the side part (16) to the front face (12) of the cylinder head (2).

5. The mounting device as recited in one of claims 1 through 4,
wherein two adjacent hold-down devices (11), for mounting of fuel injectors (1) arranged in a line, have a one-piece design.

6. The mounting device as recited in claim 1,
wherein the hold-down device (11) has the form of a holding-down pot 17 having a one-piece design.

7. The mounting device as recited in claim 6,
wherein the holding-down pot (17) has at least one slot (19) at a downstream end (22).

8. The mounting device as recited in claim 7,
wherein the holding-down pot (17) has at least one elastically deformable clip (21) at its downstream end (22).

9. The mounting device as recited in one of claims 6 through 8,
wherein the side parts (16) of the holding-down pot (17) are each secured to the front face (12) of the cylinder head (2) by at least one screw (13) which reaches through a bore (15), or by at least one clamping claw (14) in each case.
